(19) United States
(12) Patent Application Publication
(10) Pub. No.: US 2024/0284294 A1
(43) Pub. Date: Aug. 22, 2024

(54) METHODS AND COMMUNICATIONS NODES IN A WIRELESS BACKHAUL NETWORK

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/291,223

(22) PCT Filed: Jun. 24, 2022
(86) PCT No.: PCT/EP2022/067342

§ 371 Date: Jan. 23, 2024

(30) Foreign Application Priority Data
Jul. 30, 2021 (EP) 21188968.8

(51) Int. Cl. H04W 40/02; H04L 45/12; H04W 28/02

(52) U.S. Cl. CPC H04W 40/02; H04L 45/123; H04W 28/0205

(57) ABSTRACT

Methods and communications nodes for communications between communications devices, various communications nodes in a wireless backhaul network and a core network.

### BACKGROUND

### Field of Disclosure

The present disclosure relates to methods and communications nodes for communications between communications devices, various communications nodes in a wireless backhaul network and a core network.

The present disclosure claims the Paris convention priority of European patent application number EP21188968.8, filed on 30 Jul. 2021, the contents of the which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Recent generation mobile telecommunication systems, such as those based on the 3GPP defined UMTS and Long Term Evolution (LTE) architectures, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. In addition to supporting these kinds of more sophisticated services and devices, it is also proposed for newer generation mobile telecommunication systems to support less complex services and devices which make use of the reliable and wide ranging coverage of newer generation mobile telecommunication systems without necessarily needing to rely on the high data rates available in such systems. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

As radio technologies continue to improve, for example with the development of 5G, the possibility arises for these technologies to be used not only by infrastructure equipment to provide service to wireless communications devices in a cell, but also for interconnecting communications nodes wirelessly to provide a wireless backhaul. In wireless backhaul networks, a donor communications node connected to a core network can allocate communications resources to other communications nodes for communicating with the core network via the donor communications node. There may therefore be many communications paths or routes for communicating data through the wireless backhaul network. In view of the increasing capabilities and complexity of wireless backhaul networks, there is a need for improved methods, and communications nodes for routing data through a wireless backhaul network.

### SUMMARY OF THE DISCLOSURE

The present disclosure can help address or mitigate at least some of the issues discussed above as defined in the appended claims.

According to one aspect of the present technique, there is provided a method of controlling communication, by a controlling communications node, in a wireless backhaul network. The wireless backhaul network comprises a plurality of communications nodes one of which is the controlling communications node. The method comprises maintaining information by the controlling communications node relating to conditions for communicating data via a plurality of wireless communications links between the communications nodes of the wireless backhaul network. The wireless backhaul network is configured to communicate downstream data from a core network for transmitting to one or more communications devices or to communicate upstream data to the core network received from the one or more communications devices. The communications nodes of the wireless backhaul network are inter-connected with at least one of the communications nodes connected to a plurality of other communications node for communicating upstream data from the one or more communications devices to the core network or downstream data from the core network to the one or more communications devices.

The method comprises determining, based on the maintained information of conditions for communicating the data via the plurality wireless communications links of the wireless backhaul network, routing information defining one or more possible routes for communicating the upstream data or the downstream data via the plurality of wireless communications links and the conditions for communicating the upstream or the downstream data on the one or more possible routes. The method comprises communicating the routing information to one or more of the communications nodes for each of the one of more communications nodes to configure a routing table for communicating the upstream data or the downstream data on the one or more possible routes via the wireless communications links. One of the wireless communications links is formed at least in part from communications resources of an unlicensed wireless access interface, and the conditions for communicating the upstream or the downstream data on the one or more possible routes forming part of the routing information includes an indication of communications characteristics for communicating via unlicensed wireless access interfaces.

For example, the indication of communications characteristics for communicating via unlicensed wireless access interfaces can include at least one of,
a likelihood of contention when accessing communications resources of a wireless communications link;
a delay in accessing communications resources on a wireless communications link;
a signal to interference ratio when communicating via a wireless communications link;
a maximum transmission power when transmitting via a wireless communications link; and
a bandwidth when transmitting via a wireless communications link.

According to another aspect of the present technique, there is provided a method of controlling communication in a wireless backhaul network by a communications node in the wireless backhaul network, in which the communications node receives, from another communications node in the wireless backhaul network, information relating to conditions for communicating data via a plurality of wireless communications links between the communications node and the plurality of other communications nodes. The conditions for communicating the data via the plurality of wireless communications links includes an indication of communications characteristics for communicating via unlicensed wireless access interfaces. The communications node selects, based on the received information of conditions for communicating the data via the wireless communications links, one of the plurality of wireless communications links for communicating upstream or the downstream data, and communicates the upstream data or the downstream data via the selected one of the wireless communications links.

It will be appreciated by a person skilled in the art that “unlicensed wireless access” may alternatively be referred to as “shared spectrum channel access”.

The above aspects can provide improvements over existing approaches to route selection procedures in wireless backhaul networks, which do not adequately account for current or future wireless backhaul network capabilities. Particularly, the above aspects can provide an improved route selection, when one or more of the communications links uses an unlicensed frequency band in wireless backhaul networks by accounting for a capability of communications nodes in the wireless backhaul network to operate using communications resources of an unlicensed wireless access interface on the unlicensed band.

Unless otherwise specified, the terms “route” and “communications path” are used interchangeably throughout this disclosure. Furthermore, the terms “wireless backhaul network” and “communications node” are used interchangeably with the terms “JAB network” and “JAB node” respectively.

Respective aspects and features of the present disclosure are defined in the appended claims and include methods of controlling communications nodes in an JAB network, a communications node in an JAB network and a controlling node in an JAB network and an JAB network.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a LTE-type wireless telecommunication system which may be configured to operate in accordance with certain embodiments of the present disclosure;

FIG. 2 schematically represents some aspects of a new radio access technology (RAT) wireless communications system which may be configured to operate in accordance with certain embodiments of the present disclosure;

FIG. 3A is a schematic diagram illustrating a wireless backhaul network and a core network in accordance with example embodiments;

FIG. 3B is a flow diagram illustrating a first communications path in the wireless backhaul network in FIG. 3A;

FIG. 3C is a flow diagram illustrating a second communications path in the wireless backhaul network in FIG. 3A FIG. 3D is a flow diagram illustrating a third communications path in the wireless backhaul network in FIG. 3A FIG. 4 is a schematic diagram illustration a path cost calculation in accordance with example embodiments;

FIG. 5 is a flow diagram illustrating a method of controlling communications, by a controlling communications node, in a wireless backhaul network according to example embodiments;

FIG. 6 is a flow diagram illustrating a method of controlling communication by a communications node in a wireless backhaul network;

FIG. 7 is a schematic block diagram of some components of the wireless communications system shown in FIG. 2 in more detail in order to illustrate example embodiments of the present technique.

### DETAILED DESCRIPTION OF THE EMBODIMENTS

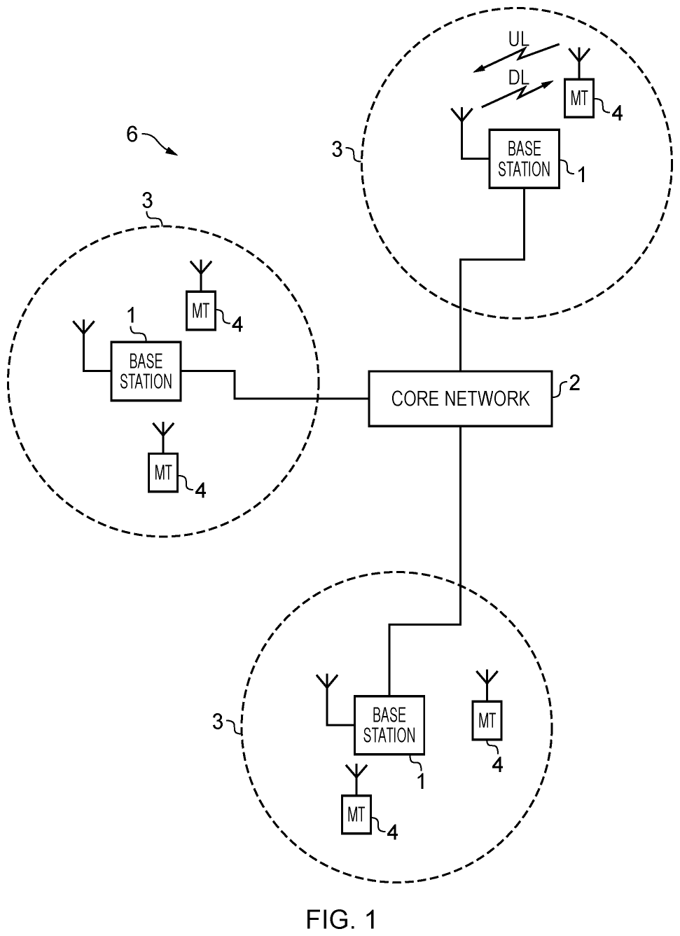

Long Term Evolution (LTE) Wireless Communications System FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G) Wireless Communications System

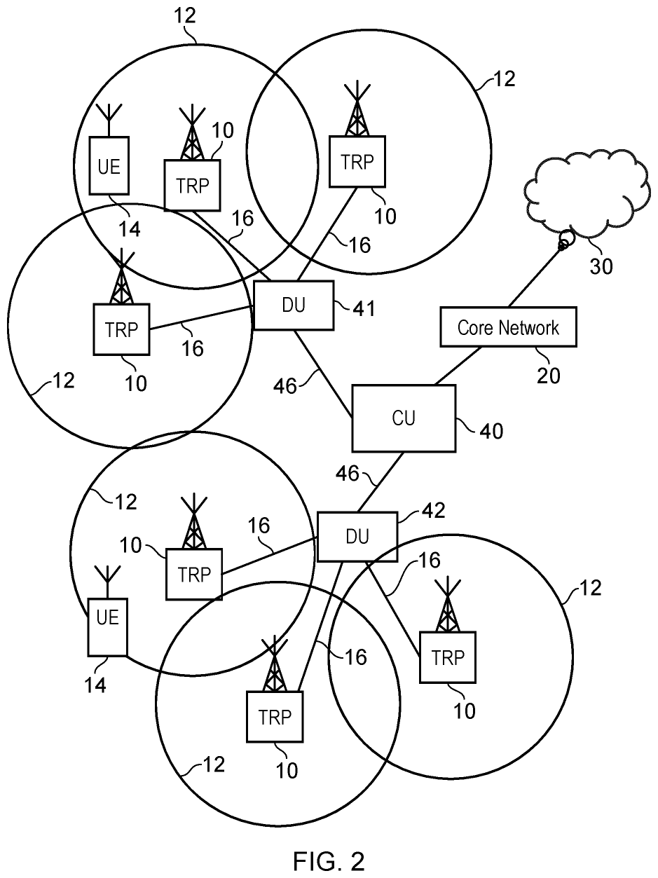

An example configuration of a wireless communications network which uses some of the terminology proposed for NR and 5G is shown in FIG. 2. A 3GPP Study Item (SI) on New Radio Access Technology (NR) has been defined [2]. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling communications node) via an interface 46. The central unit 40 is then connected to the a core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems.

Depending on the application at hand the responsibility for scheduling transmissions which are scheduled on the radio interface between the respective distributed units and the communications devices may lie with the controlling communications node/central unit and/or the distributed units/TRPs. A communications device 14 is represented in FIG. 2 within the coverage area of the first communication cell 12. This communications device 14 may thus exchange signalling with the first central unit 40 in the first communication cell 212 via one of the distributed units 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a central unit 40, which can act as a controlling communications node of an JAB network and/or a TRP 10 of the kind shown in FIG. 2 which is adapted to provide functionality in accordance with the principles described herein.

Integrated Access and Backhaul (IAB) for NR A new study item on Integrated Access and Backhaul for NR [3] has been approved. Several requirements and aspects for the integrated access and wireless backhaul for NR to address are discussed in [3], which include:
Efficient and flexible operation for both inband and outband relaying in indoor and outdoor scenarios;
Multi-hop and redundant connectivity;
End-to-end route selection and optimisation;
Support of backhaul links with high spectral efficiency;
Support of legacy NR UEs.

The stated objective of the study detailed in [3] is to identify and evaluate potential solutions for topology management for single-hop/multi-hop and redundant connectivity, route selection and optimisation, dynamic resource allocation between the backhaul and access links, and achieving high spectral efficiency while also supporting reliable transmission.

Integrated Access and Backhaul is a technique in which wireless infrastructure equipment form a wireless connection of an radio network infrastructure equipment to the core network, which would conventionally be provided by a wired connection.

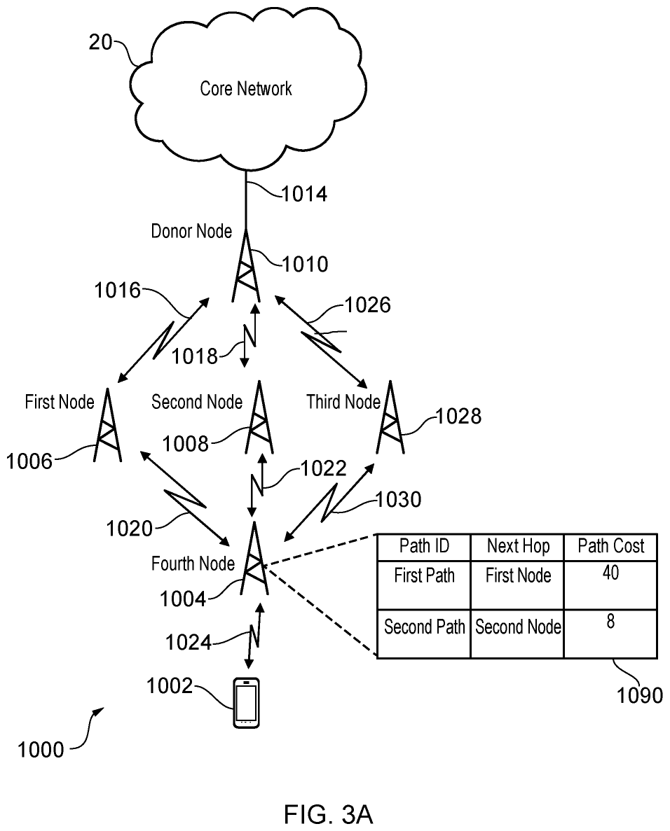

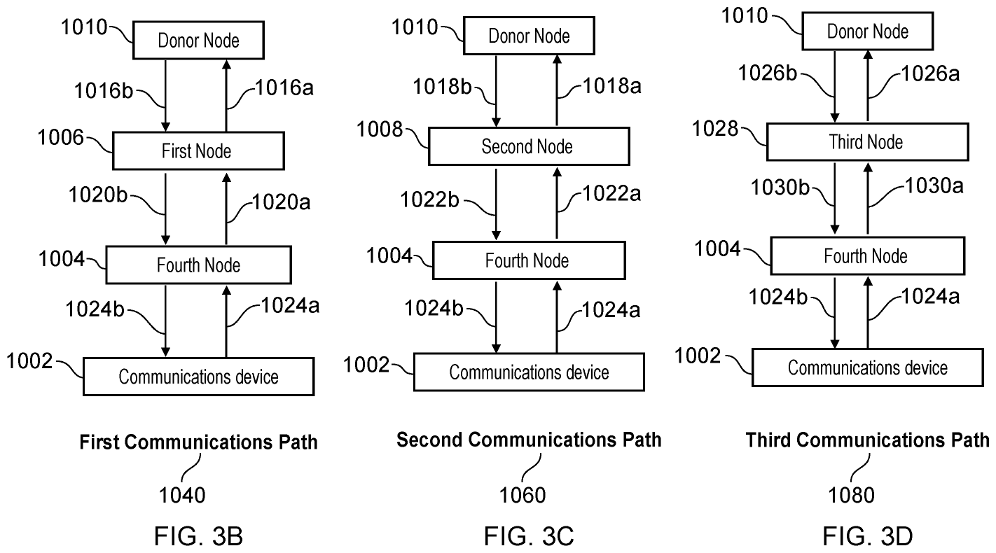

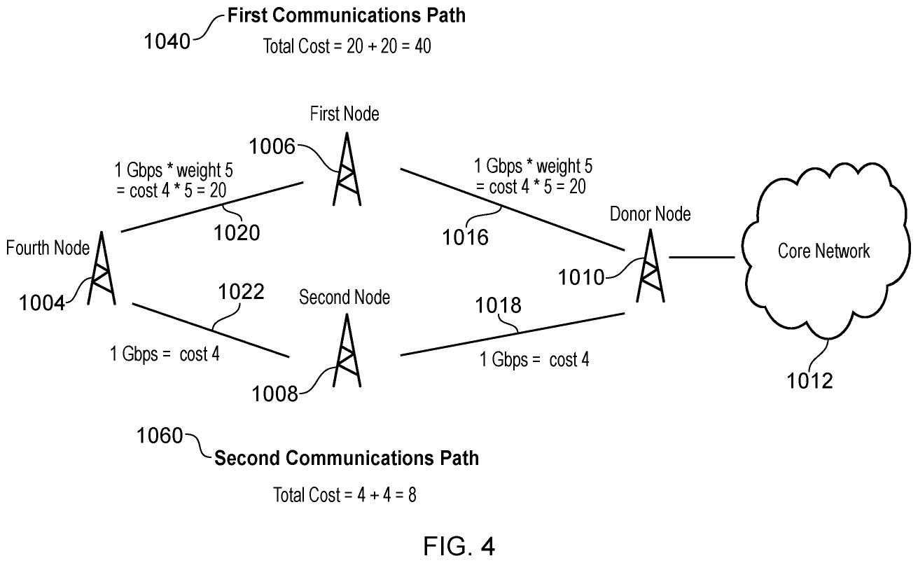

Example arrangements of the present technique can be formed from a wireless communications network corresponding to that shown in FIG. 1 or 2, as shown in FIG. 3A. FIG. 3A provides an example in which cells of a wireless communications network are formed from communications nodes which are provided with an Integrated Access and Backhaul (IAB) capability. The wireless communications network 1000 comprises the core network 20 and a wireless backhaul network, which includes a plurality of communications nodes 1004, 1006, 1008, 1010, 1028. The plurality of communications nodes 1004, 1006, 1008, 1010, 1028 include a donor communications node 1010 and a plurality of other communications nodes 1004, 1006, 1008, 1028 including a first 1006, second 1008, third 1028 and fourth communications node 1004. The wireless communications network 1000 also comprises a communications device 1002 which may broadly correspond to the communications device 4 described above.

Each of the plurality of communications nodes 1004, 1006, 1008, 1010, 1028 may be configured to provide a coverage area (i.e. a cell, not shown in FIG. 3A) within which data can be communicated to and from one or more communications devices. For example, the fourth communications node 1004 provides a cell in which the communications device 1002 may obtain service. Data is transmitted from the fourth communications node 1004 to the communications device 1002 within its respective coverage area (not shown) via a radio downlink over an access link 1024. Data is transmitted from the communications device 1002 to the fourth communications node 1004 via a radio uplink over the access link 1024.

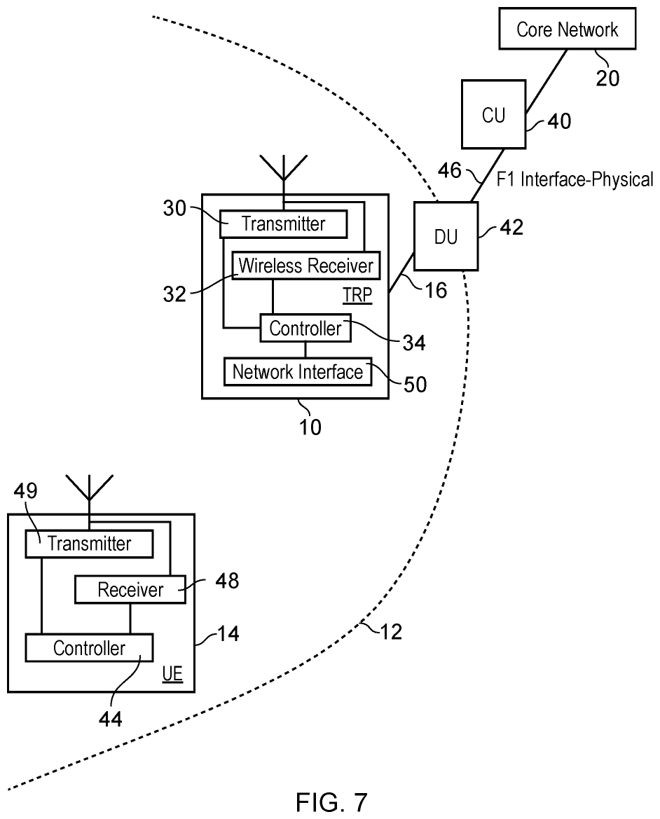

The plurality of communications nodes 1004, 1006, 1008, 1010, 1028 in FIG. 3A may comprise at least transmitter circuitry, receiver circuitry and controller or processor circuitry as will be explained shortly with reference to FIG. 7. In some embodiments, a communications node may be an infrastructure equipment. For example, the plurality of communications nodes 1004, 1006, 1008, 1010, 1028 may correspond broadly to the TRPs 10 of FIG. 2. In some embodiments, the functionality of a communications node (other than the donor communications node 1010) may be carried out by a communications device, which may be the communications device 4 (of FIG. 1) or 14 (of FIG. 2), adapted accordingly.

The donor communications node 1010 in FIG. 3A is connected to the core network 20 by means of one or a series of physical connections 1014. The donor communications node 110 may comprise the TRP 10 (having the physical connection 16 to the DU 42) in combination with the DU 42 (having a physical connection to the CU 40 by means of the F1 interface 46) and the CU 40 (being connected by means of a physical connection to the core network 20).

However, there is no direct physical connection between any of the first to fourth communications nodes 1004, 1006, 1008, 1028 and the core network 20. As such, it may be necessary or, otherwise determined to be appropriate for data received from a communications device (i.e. uplink data), or data for transmission to a communications device (i.e. downlink data) to be transmitted to or from the core network 20 via a communications node (such as the donor communications node 1010) which has a physical connection to the core network 20, even if the communications device is not currently served by the donor communications 1010 but is served by another communications node in the wireless backhaul network. For example, in FIG. 3A, the communications device 1002 is served by the fourth communications node 1004. Therefore data received by the fourth communications node 1004 from the communications device 1002 for transmission to the core network 20 may be forwarded to the donor communications node 1010 and data received from the core network 20 by the donor communications node 1010 for transmission to the communications device 1002 may be forwarded to the fourth communications node 1004.

The first to fourth 1004, 1006, 1008, 1028 in FIG. 3A may each comprise a TRP, broadly similar in functionality to the TRPs 10 of FIG. 2.

According to some embodiments, one or more of the first to fourth communications nodes 1004, 1006, 1008, 1028 in FIG. 3A may further comprise a DU 42, and in some arrangements, one or more of the first to fourth communications nodes 1004, 1006, 1008, 1028 may comprise a DU and a CU.

In some embodiments, a CU (such as CU 40) associated with the donor communications node 1010 may perform the function of a CU not only in respect of the donor communications 1010, but also in respect of one or more of the first to fourth communications nodes 1004, 1006, 1008, 1028.

As shown in FIG. 3A, the donor communications node 1010 is configured to communicate with the first communications node 1006, the second communications node 1008 and the third communications node 1028 via respective wireless backhaul links 1016, 1018, 1026. In this case, the donor communications node 1010 provides communications resources to the first communications node 1006, the second communications node 1008 and the third communications node 1028 for communications over the respective wireless backhaul links 1016, 1018, 1028. As such, the donor communications node 1010 is acting as a “parent node” to the first communications node 1006, the second communications node 1008 and the third communications node 1028, which may therefore be referred to as “child nodes” of the donor communications node 1010.

As shown in FIG. 3A, the first communications node 1006, the second communications node 1008 and the third communications node 1028 are configured to communicate with a fourth communications node 1004 over respective wireless backhaul links 1020, 1022, 1030 to the fourth communications node 1004.

The first communications node 1006, the second communications node 1008 and the third communications node 1028 may provide communications resources to the fourth communications node 1004 for communications over the respective wireless backhaul links 1020, 1022, 1030. As will be appreciated, the communications resources provided by the first communications node 1006, the second communications node 1008 or the third communications node 1028 to the fourth communications node 1004 are derived from the respective communications resources provided to the first communications node 1006, the second communications node 1008 or the third communications node 1028 by the donor communications node 1010. In this case, the fourth communications node 1004 may be regarded as a child node of each of the first communications node 1006, the second communications node 1008 and the third communications node 1028. Correspondingly, the first communications node 1006, the second communications node 1020 and the third communications node 1028 may be referred to as parent nodes of the fourth communications node 1004.

As shown in FIG. 3A, the fourth communications node 1004 provides communications resources to a communications device 1002 over an access link 1024 which can be used by the communications device 1002 for communication with the fourth communications node 1004. As will be appreciated, the communications resources provided by the fourth communications node 1004 to the communications device 1002 are ultimately derived from the communications resources provided by the donor communications node 1010. In this example, since the fourth communications node 1004 is providing access for at least one communications device, it may also be referred to as an “access communications node” or an “end communications node”.

Each of the wireless backhaul links 1020, 1022, 1028, 1016, 1018, 1026, which may alternatively be referred to as inter-node wireless communications links, may be provided by means of a respective wireless access interface. Alternatively, two or more of the inter-node wireless communications links 1020, 1022, 1028, 1016, 1018, 1026 may be provided by means of a common wireless access interface and in particular, in some arrangements of the present technique, all of the inter-node wireless communications links 1020, 1022, 1028, 1016, 1018, 1026 are provided by a shared wireless access interface.

A wireless access interface which provides a wireless backhaul link may also be used for communications between an infrastructure equipment (which may be a communications node) and a communications device which is served by the infrastructure equipment. For example, the communications device 1002 may communicate with fourth communications node 1004 using the wireless access interface which provides the wireless backhaul link 1020 connecting the fourth communications node 1004 and the first communications node 1006.

The wireless access interface(s) providing the wireless backhaul links 1020, 1022, 1028, 1016, 1018, 1026 may operate according to any appropriate specifications and techniques. In some embodiments, a wireless access interface used for the transmission of data from one communications node to another uses a first technique and a wireless access interface used for the transmission of data between a communications node and a communications device may use a second technique different from the first.

In some embodiments, the wireless access interface(s) used for the transmission of data from one communications node to another and the wireless access interface(s) used for the transmission of data between a communications node and a communications device use the same technique.

Examples of wireless access interface standards include the third generation partnership project (3GPP)-specified GPRS/EDGE (“2G”), WCDMA (UMTS) and related standards such as HSPA and HSPA+(“3G”), LTE and related standards including LTE-A (“4G”), and NR (“5G”). Techniques that may be used to provide a wireless access interface include one or more of TDMA, FDMA, OFDMA, SC-FDMA, CDMA. Duplexing (i.e. the transmission over a wireless link in two directions) may be by means of frequency division duplexing (FDD) or time division duplexing (TDD) or a combination of both.

In some embodiments, two or more of the wireless backhaul links 1020, 1022, 1028, 1016, 1018, 1026 may share communications resources. This may be because two or more of the wireless backhaul links 1020, 1022, 1028, 1016, 1018, 1026 are provided by means of a single wireless access interface or because two or more of the wireless backhaul links 1020, 1022, 1028, 1016, 1018, 1026 nevertheless operate simultaneously using a common range of frequencies.

The nature of the wireless backhaul links 1020, 1022, 1028, 1016, 1018, 1026 may depend on the architecture by which the wireless backhaul functionality is achieved.

As explained below a communications node in an JAB network may use a routing table such as the routing table 1090 shown in FIG. 3A to route data via the network.

As will be explained and illustrated below, example embodiments include at least one communications link between JAB nodes, which utilises an unlicensed frequency band, and a wireless access interface which utilises the unlicensed frequency band. Effectively this can mean that access to the communications resources of the unlicensed frequency band is not controlled by an entity. An example of an unlicensed frequency band wireless access technique is WiFi.

Various architectures have been proposed in order to provide the JAB functionality. The below described embodiments are not restricted to a particular architecture. However, a number of candidate architectures which have been considered in, for example, 3GPP document [4]. A detailed description of candidate architectures is also provided in our co-pending European patent application 19794157.8, the contents of which are hereby incorporated by reference in their entirety.

### Communications Paths in IAB Networks

As will be appreciated, in order to communicate data from the communications device 1002 to the core network 20, it is not necessary for all of the wireless backhaul links 1016, 1018, 1026, 1020, 1022, 1030 to be simultaneously active. Data may be successfully communicated along any complete communications path between the communications device 1002 and the donor communications node 1010.

In order to provide the transmission of the uplink data or the downlink data between a communications device and the core network, a communications path is determined by any suitable means, with one end of the communications path being a donor communications node physically connected to a core network and by which uplink and downlink traffic is routed to or from the core network.

FIGS. 3B, 3C and 3D show three examples of complete communications paths for communicating data between the communications device 1002 and the donor communications node 1010 in the wireless backhaul network shown in FIG. 3A.

FIG. 3B illustrates a first communications path 1040 which includes the communications device 1002, the fourth communications node 1004, the first communications node 1006 and the donor communications node 1010. As shown in FIG. 3B, the first communications path 1040 may be used to transmit uplink data from the communications device 1002 to the donor communications node 1010 consisting of an uplink transmission 1024a from the communications device 1002 to the fourth communications node 1004, an uplink transmission 1020a from the fourth communications node 1004 to the first communications node 1006 and an uplink transmission 1016a from the first communications node 1006 to the donor communications node 1010. Alternatively, the first communications path 1040 may be used to transmit downlink data from the donor communications node 1010 to the communications device 1002 consisting of a downlink transmission 1016b from the donor node to the first communications node 1006, a downlink transmission 1020b from the first communications node 1006 to the fourth communications node 1004 and a downlink transmission 1024b from the fourth communications node 1004 to the communications device 1002.

FIG. 3C illustrates a second communications path 1060 which includes the communications device 1002, the fourth communications node 1004, the second communications node 1006 and the donor communications node 1010. As shown in FIG. 3C, the second communications path 1060 may be used to transmit uplink data from the communications device 1002 to the donor communications node 1010 consisting of an uplink transmission 1024a from the communications device 1002 to the fourth communications node 1004, an uplink transmission 1022a from the fourth communications node 1004 to the second communications node 1008 and an uplink transmission 1018a from the second communications node 1008 to the donor communications node 1010. Alternatively, the second communications path 1060 may be used to transmit downlink data from the donor communications node 1010 to the communications device 1002 consisting of a downlink transmission 1018b from the donor node to the second communications node 1008, a downlink transmission 1022b from the second communications node 1008 to the fourth communications node 1004 and a downlink transmission 1024b from the fourth communications node 1004 to the communications device 1002.

FIG. 3D illustrates a third communications path 1080, which includes the communications device 1002, the fourth communications node 1004, the third communications node 1028 and the donor communications node 1010. As shown in FIG. 3D, the third communications path 1080 may be used to transmit uplink data from the communications device 1002 to the donor communications node 1010 consisting of an uplink transmission 1024a from the communications device 1002 to the fourth communications node 1004, an uplink transmission 1030a from the fourth communications node 1004 to the third communications node 1028 and an uplink transmission 1026a from the third communications node 1028 to the donor communications node 1010. Alternatively, the third communications path 1080 may be used to transmit downlink data from the donor communications node 1010 to the communications device 1002 consisting of a downlink transmission 1026b from the donor node to the third communications node 1028, a downlink transmission 1030b from the third communications node 1028 to the fourth communications node 1004 and a downlink transmission 1024b from the fourth communications node 1004 to the communications device 1002.

Accordingly, uplink or downlink data may be transmitted between the communications device 1002 and the core network 20 via either the first communications path 1040, the second communications path 1060 or the third communications path 1080. In all of the above cases, uplink data received by the donor communications node 1010 may be forwarded to the core network 20, and downlink data is transmitted from the core network 20 to the donor communications node 1010.

For the purposes of the present disclosure, a “next-hop communications node” from the perspective of particular communications node, is a communications node with which the particular communications node can directly communicate without relaying communications. For example, the donor communications node (for uplink data) 1010 and the fourth communications node (for downlink data) 1006 are next-hop communications nodes from the perspective of the first communications node 1006.

For the purposes of the present disclosure, the term ‘upstream data’ is used to describe data, which is transmitted from a communications device to a core network via a wireless backhaul network. For example, data transmitted along the first communications path 1040 from the communications device 1002 to the donor communications node 1010 via uplink transmissions 1024a, 1020a, 1016a may be referred to as upstream data. Similarly, the term ‘downstream data’ is used to describe data, which is transmitted from a core network to a communications device via a wireless backhaul network. For example, data transmitted along the first communications path 1040 from the donor communications node 1010 to the communications device 1002 via downlink transmissions 1024b, 1020b, 1016b may be referred to as downstream data

In some embodiments, an infrastructure equipment acting as a communications node may not provide a wireless access interface for the transmission of data to or by a communications device other than as part of an intermediate transmission along a communications path.

In some embodiments, a communications path is defined considering a communications device (such as the wireless communications device 1002) as the start of a communications path. In other examples a communications path is considered to start at a communications node which provides an access interface for the transmission of the uplink data by a wireless communications device (such as the fourth communications node 1004).

Topology Adaptation/Route Selection Topology adaptation refers to the arrangement of communications nodes in a wireless backhaul network and, particularly, refers to the arrangement of wireless backhaul links between the communications nodes which enable data to be routed between communications devices and a core network. Given the vulnerable characteristics of wireless links, and considering multi-hops on the backhaul link, topology adaptation for wireless backhaul networks is under consideration by the 3^{rd} Generation Partnership Group (3GPP).

Conventionally, topology adaptation is triggered by a detection of a radio link failure (RLF) caused by blockages or congestion which occurs for a wireless backhaul link between two JAB nodes. In such cases, topology adaptation may be performed to re-route data in the wireless backhaul network to avoid congested or blocked wireless backhaul links. However, as will be explained in more detail below, topology adaptation may be triggered in other ways. For example, topology adaptation may be triggered to avoid unreliable wireless communications links or to improve load balancing.

In some cases, the new route may be determined by CU. For example, a CU may detect that an RLF has occurred for a wireless backhaul link, based on, for example, reports received from JAB nodes in the JAB network and in response, selects a new route which avoids the failed wireless backhaul link. The CU may then transmit this route to the communications nodes in the JAB network which transmit data in accordance with the new route. Alternatively, an JAB node may detect an RLF failure of a wireless backhaul link on a route it uses for communication in the wireless backhaul network (based on, for example, reports received from the core network or other JAB nodes) and, in response, the JAB node selects a next-hop node on a route which avoids the failed wireless backhaul link. The JAB node may be aware of alternative routes by analysing a routing table received from the CU. Scenarios in which an JAB node determines the new route for data transmission are known as “local re-routing” scenarios. Further information regarding agreed RLF scenarios are detailed in [5].

According to conventional methods, a route selection procedure, that is a selection of a communications path for transmitting uplink or downlink data when there are multiple communications paths available may be triggered by an RLF. In one example, the fourth communications node 1004 may receive data in uplink communications from the communications device 1002 via the access link 1024. The fourth communications node 1004 will then forward the data to either the first communications node 1006, the second communications node 1008, or the third communications node 1028 which forwards the data in turn to the donor communications node 1010. The donor communications node 1010 then forwards the data onto the core network 20. In one example, the uplink data may be being communicated from the communications device 1002 to the donor communications node 1010 via the third communications path 1080 (i.e. via the third communications node 1028). When a route change procedure is triggered (for example, in response to a detection that a wireless backhaul link on the third communications path 1080, such as wireless backhaul link 1030, has failed), the fourth communications node 1004 switches from transmitting the data received from the communications device 1002 to the third communications node 1028 via the third communications path 1080 to transmitting the data via either the first communications path 1040 or the second communications path 1060. In other words, the wireless backhaul network is then faced with a decision of whether to transmit data via the first communications path 1040 or the second communications path 1060.

In our co-pending European patent application 19794157.8, the contents of which are incorporated by reference in their entirety, a solution was proposed to improve methods of route selection when a route section procedure has been triggered. JAB nodes use a “path cost” associated with a plurality of communications paths to the same destination JAB node to select a new, optimal route for data transmission in the JAB network. The path cost was calculated based on, for example, packet delay and bandwidth associated with wireless backhaul links on each of the plurality of communications paths. As such in accordance with some example embodiments different packets may be routed differently via the IAB network nodes depending on, for example, a type of data being carried or a quality of service (QoS) requirement for a bearer across the JAB network. Accordingly, as explained below selection of a route for communicating data across the JAB network may be based on characteristics of the communications path other than RLF.

The 3GPP group is currently considering local re-routing in contexts other than RLF scenarios such as those discussed above. In particular, the 3GPP group are considering:
A type-2 RLF indication which may be used to trigger local re-routing.
A hop-by-hop flow control indication to trigger local re-routing (details of trigger information, trigger conditions, and the role of the core network have not yet been decided).
Support for inter-donor-DU local re-routing.
Support inter-topology routing via BAP header rewriting based on a BAP routing ID.
Support for the IAB-donor configuring (alternative) egress links that can be used at local re-routing (at least with same destination, and same routing ID).
Local re-routing based on flow control feedback based on certain values of available buffer size.

There are many challenges to overcome and aspects to consider when providing route change procedure solutions. Firstly, it must be determined how problems with routes are detected and how measurement reports and/or assistance information may be used to decide when routes should be changed with respect to the intermediate nodes. Such problems may include link quality deterioration of the route as a whole or at one or more of the nodes on the route, traffic loads at one or more of the nodes on the route, or capacity issues or a node status at one or more of the nodes on the route, such as a buffer status or a power headroom status. Secondly, the way in which route selection criteria and decision making must be determined. This includes the route selection meeting any QoS requirements, the securing of capacity, reserving of resources, admission control requirements and means by which the route can be adapted or simplified. Thirdly, it must be determined how the selected links or updated routes are indicated to the relevant nodes in the system. For example, an indication of a route change may be provided to all or a part of intermediate nodes on both the old route and the new route.

However, as the capabilities of JAB networks develop, there is room to improve current approaches to local re-routing and, in particular to improve route selection procedures, to provide optimal route selection which takes account of current or future JAB network capabilities.

### Unlicensed Band Operation in IAB Networks

As will be appreciated by one skilled in the art, communications devices are configured to communicate with infrastructure equipment using communications resources of a wireless access interface which comprise time and frequency resources. Such communications resources may be licensed or unlicensed. Licensed communications resources (or licensed bands) are communications resources which have been licensed for exclusive use by a particular network operator. By contrast, unlicensed communications resources (or unlicensed bands) are communications resources which have not been exclusively licensed to a network operator, and therefore represent an access of a channel which includes a spectrum which is shared with another radio access technology or interface. For example, an JAB network may share unlicensed communications resources with a Wi-Fi network. As such, collisions may occur between transmissions from competing communications devices or infrastructure equipment operating on the same unlicensed communications resources. Typically, a communications device or infrastructure equipment wishing to operate on unlicensed communications resources performs a listen-before-talk (LBT) procedure to check if the resources are available for use. If usage of the resources is detected, then transmission is delayed until the resources are available. Consequently, the use of unlicensed communications resources may lead to a degradation of in quality of service (QoS). On the other hand, unlicensed bands provide an increased bandwidth to be used by network operators which may not have been available if they were licensed for exclusive use.

Furthermore, different unlicensed bands may be associated with different characteristics. For example, unlicensed bands at higher frequencies (such as millimetre wave bands at 57-64 GHz) may be associated with a higher bandwidth, and therefore may support a higher throughput, than unlicensed bands at lower frequencies (such as bands at 2.4 GHz used for WiFi).

There has been a recent increase in the amount of millimetre wave unlicensed bands. For example, the Federal Communications Commission (FCC) released approximately 14 GHz for unlicensed use in the 57-64 GHz band. As such, the released 14 GHz can be used by operators to offload traffic from existing cellular networks.

It is recognised herein that future JAB nodes may be configured to operate on unlicensed communications resources to exploit the extra bandwidth provided by those resources. However, it is expected that the operation of JAB nodes on unlicensed bands will give rise to a number of technical challenges, particularly with regard to optimising route selection procedures. This is because communications via an unlicensed band can have characteristics, which are different from a licensed band caused by a presence of communications by other radio access technologies. Key characteristics of communications in an unlicensed band can include:
1) Contention, caused by collisions when accessing the communications resources on the unlicensed band, which may be represented for example as a time to access the channel or a likelihood of contention;
2) No coordination between access points, potentially causing interference as a result of mixing different wireless system;
3) A limitation on a maximum transmit power limitation, compared to licensed band;
4) A sensing requirement before transmission (listen before talk method) causing a variable amount of delay.

However, mmWave unlicensed band may reduce the drawbacks mentioned above, for example because there are no collisions or at least a reduced amount with a wider bandwidth, less interference with narrow beamforming. As will be appreciated therefore there is a desire to make use of an unlicensed band for JAB under the conditions that potential disadvantages of the unlicensed band are low by evaluating such communications conditions of the unlicensed band before using.

In view of the above, according to example embodiments, a method of controlling communication, by a controlling communications node, in a wireless backhaul network. The wireless backhaul network comprises a plurality of communications nodes one of which is the controlling communications node. The method comprises maintaining information by the controlling communications node relating to conditions for communicating data via a plurality of wireless communications links between the communications nodes of the wireless backhaul network. The wireless backhaul network is configured to communicate downstream data from a core network for transmitting to one or more communications devices or to communicate upstream data to the core network received from the one or more communications devices. The communications nodes of the wireless backhaul network are inter-connected with at least one of the communications nodes connected to a plurality of other communications node for communicating upstream data from the one or more communications devices to the core network or downstream data from the core network to the one or more communications devices. The method comprises determining, based on the maintained information of conditions for communicating the data via the plurality wireless communications links of the wireless backhaul network, routing information defining one or more possible routes for communicating the upstream data or the downstream data via the plurality of wireless communications links and the conditions for communicating the upstream or the downstream data on the one or more possible routes. The method comprises communicating the routing information to one or more of the communications nodes for each of the one of more communications nodes to configure a routing table for communicating the upstream data or the downstream data one the one or more possible routes via the wireless communications links. One of the wireless communications links is formed at least in part from communications resources of an unlicensed wireless access interface, and the routing information includes an indication that the wireless communications link is formed at least in part from an unlicensed wireless access interface, which is use to configure the routing table from which the one or more of communications nodes can select one or more of the possible routes based on the routing information including whether the wireless communications link is formed from an unlicensed wireless access interface.

The indication of communications characteristics for communicating via unlicensed wireless access interfaces may include a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and/or a bandwidth when transmitting via a wireless communications link. The communications characteristics may relate to typical characteristics associated with unlicensed wireless access interfaces or may specifically relate to the at least one wireless communications link in the wireless backhaul network which is formed from the unlicensed wireless access interface. The indication of communications characteristics for communicating via unlicensed wireless access interfaces may include an indication that the least one of the wireless communications links is formed from communications resources of an unlicensed wireless access interface. This indication may be an indication that a communications node which uses that wireless communications link for communication is configured to operate on unlicensed frequency resources. Alternatively, this indication may indicate that the communications node can only operate on unlicensed frequency resources or can choose to operate either on licensed or unlicensed frequency resources.

Embodiments can improve an efficiency of routing of JAB data packets via an JAB network, which includes at least one wireless communications link interconnecting JAB communications nodes, formed at least in part from communications resources of an unlicensed or shared radio frequency band. The unlicensed band may be shared with other radio access technologies, which may cause contention communications on the JAB network. On the other hand, the communications link via the unlicensed band may provide an advantage of a higher bandwidth, albeit a bandwidth which varies in time as contention with the other radio access technologies, with which the communications link on the unlicensed band, is shared increases and decreases. By providing an indication of communications characteristics for communicating via unlicensed wireless access interfaces with the routing information, a communications node can select a route for JAB data packets based on a more objective evaluation of each of a plurality of routes, which may include a wireless communication link formed from communications resources of an unlicensed band.

An example scenario in which advantages provided by example embodiments are apparent will now be described with reference to FIGS. 3A to 3D. In one example, the fourth communications node 1004 may initially be communicating with the core network 20 via the third communications path 1080 which includes the third communications node 1028. Subsequently a route selection procedure may be triggered. In example embodiments, a route selection procedure is triggered because the wireless backhaul link 1030 between the fourth communications node 1004 and the third communications node 1028 fails. However, other triggers are envisaged as will be explained in more detail below. In accordance with example embodiments, the first communications node 1006 may be configured to operate on unlicensed frequency resources. In other words, at least one of the wireless backhaul links 1016, 1020 which the first communications node 1006 uses for the communication of data may be formed at least in part using communications resources of an unlicensed wireless access interface.

By contrast, the second communications node 1008 may not be configured to operate on unlicensed communications resources, and instead only operates using licensed communications resources. The ability of a communications node to operate on unlicensed communications resources or not may depend on the communications resources allocated to that communications node from the donor communications node 1010. In other words, in some embodiments, the donor communications node 1010 may determine whether to configure another communications node in the wireless backhaul network with unlicensed communications resources or not. Alternatively, the core network 20 may determine whether the donor communications node 1010 should configure another communications node in the wireless backhaul network with unlicensed communications resources or not.

In accordance with example embodiments, the fourth communications node 1004 may receive an indication that at least one wireless communications link, such as the wireless backhaul links 1016, 1020 used by the first communications node 1006, is formed at least in part using communications resources of an unlicensed wireless access interface. For example, the fourth communications node 1004 may receive an indication from the core network 20 or from the donor node 1010, or from the first communications node 1006, that the first communications node 1006 is configured to operate on unlicensed communications resources as will be explained in more detail below.

In accordance with some embodiments, the fourth communications node 1004 selects between the first communications path 1040 and the second communications path 1060, and in particular selects whether to transmit data received from the communications device 1002 to the first communications node 1006 or the second communications node 1008 as a next-hop node, based on the indication that the first communications node 1006 operates on unlicensed frequency resources.

In some scenarios it may be disadvantageous for the fourth communications node 1004 to forward the uplink data to the first communications node 1006 which operates on unlicensed communications resources. For example, as explained above, data communicated on unlicensed communications resources is more likely to suffer from collisions with other devices competing for the unlicensed communications resources. In such scenarios, the fourth communications node 1004 may determine to forward the uplink data to the second communications node 1008 along the second communications path 1060. However, in other scenarios, it may be advantageous to forward the uplink data to the first communications node 1006 which operates on unlicensed communications resources. For example, the unlicensed communications link may offer higher bandwidths, the use of unlicensed bands may allow for increased throughput. In any case, whether communicating the data on unlicensed communications resources is beneficial may depend on the type of data being transmitted. For example, for data with stringent latency requirements, it may be more important that the data is transmitted from the communications device 1002 to the core network 20 using the least number of hops, even if this means using nodes which operate on unlicensed communications resources. In such scenarios, the fourth communications node 1004 may forward the uplink data to the first communications node 1006 along the first communications path 1040.

### Path Cost

In accordance with example embodiments, a path cost may be used to assist in route selection. Path cost is essentially a hypothetical cost value which may be partially based on the link capacity/bandwidth between JAB nodes or along routes. For example, assuming the following cost table reproduced from [6]:

TABLE 1
Path cost calculation of IEEE 802.1D-
1998 Spanning Tree Protocol (SPT).

| | |
|---|---|
| Link capacity | Cost |

| | | |
|---|---|---|
| 10 | Gbps | 2 |
| 1 | Gbps | 4 |
| 100 | Mbps | 19 |
| 10 | Mbps | 100 |

It will be appreciated by one skilled in the art that JAB link cost may be variable and dynamically changed. For example, the link (channel) quality, or the load of a node's processing may have an impact on the link cost. There may be pre-defined preferences; for example, a node may have a good directional antenna. Therefore, the path cost, in the context of JAB networks, is no longer simply a one-to-one mapping of link capacity. The cost calculation may need to take multiple factors into account. For example, these factors may include the sum of link capacity, stability of channel quality, and the room of processing load at each node, etc. In accordance with example embodiments, a path cost of wireless communications links on routes may be adapted to reflect whether nodes on a particular route are configured to operate using unlicensed communications resources.

FIG. 4 illustrates an example of a path cost calculation in accordance with example embodiments. In this example, the calculation comprises simply cumulating the sum of each link cost. As shown in FIG. 4, the link cost of each of the wireless backhaul links 1018, 1022 on the second communications path 1060 is equal—each link has a cost of “4” which corresponds to a data bit rate of 1 Gbps in this example (see Table 1 above). Accordingly, the second communications path 1060 has a total path cost of “8”. Furthermore, as shown in FIG. 4, each of the wireless backhaul links 1020, 1016 on the first communications path 1040 have the same bit rate (1 Gbps) as each of the wireless backhaul links 1018, 1022 on the second communications path 1060. Therefore, before any weighting is applied, the first communications path 1040 and the second communications path 1060 would have the same total path cost. In accordance with example embodiments, the link cost of each link operating on unlicensed communications resources may be adapted to reflect that those links operate on unlicensed communications resources. In this example, the wireless backhaul links 1020, 1016 on the first communications path 1040 which are associated with the first communications node 1006 are operating on unlicensed communications resources. In this example, a weighting of “5” is applied to the link cost of each link operating on unlicensed communications resources. It will be appreciated that applying a weighting of “5” to each link cost is one example of adapting a path cost to account for the use of unlicensed frequency resources and other methods of adaptation may be used. For example, a different weighting may be used or an additional link cost may be added to links operating on unlicensed communications resources. In some embodiments, a superior value of path cost may be the lowest path cost. For example, the fourth communications node 1004 may select to transmit data along the second communications path 1060 because it has a lower total path cost or average link path cost than the first communications path 1040. In such embodiments, the weighting of “5” applied to links operating on unlicensed communications resources may reflect that it would be disadvantageous for the fourth communications node 1004 to transmit data along a communications path which uses unlicensed communications resources because of the increased likelihood of collisions/contention for those resources. In other embodiments, a superior value of path cost may be the higher path cost. For example, the fourth communications node 1004 may select to transmit data via the first communications path 1040 because it has a higher path cost than the second path cost. In such embodiments, the weighting of “5” applied to links operating on unlicensed communications resources may reflect that it would be advantageous for the fourth communications node 1004 to transmit data along a communications path which uses unlicensed communications resources because of an increased bandwidth offered by those resources.

For simplicity, the example above considered the link cost of each link as being calculated based on a data bit rate and an indication of whether the link operates using unlicensed frequency resources. In some arrangements of embodiments of the present technique, the link cost may be calculated based on an indication of whether the link operates using unlicensed frequency resources and one or more of a link capacity, link quality, link delay or link load. In some embodiments, the link cost may be based only on an indication of whether the link operates using unlicensed communications resources.

### Routing Tables

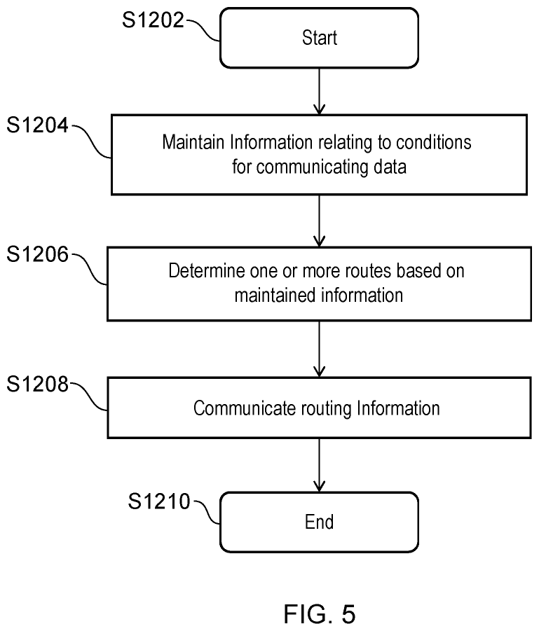

FIG. 5 is a flow diagram illustrating a method of controlling communications in a wireless backhaul network according to example embodiments. The method is performed by a controlling communications node in a wireless backhaul network comprising a plurality of communications nodes, one of which is the controlling node. The controlling communication node may be a CU in one example. For example, the controlling communications node may be a donor communications node in the wireless backhaul network. The method starts at step S1202. In step S1204, the controlling communications node maintains information relating conditions for communicating data via a plurality of wireless communications links (such as wireless backhaul links 1016, 1018, 1026, 1020, 1022, 1030) between the communications nodes of the wireless backhaul network. The controlling node may have received this information based on reports received from communications nodes in the wireless backhaul network. The wireless backhaul network is configured to communicate downstream data from a core network (such as core network 20) for transmitting to one or more communications devices or to communicate upstream data to the core network received from the one or more communications devices. The communications nodes of the wireless backhaul network are inter-connected with at least one of the communications nodes connected to a plurality of other communications nodes for communicating the upstream or the downstream data. For example, the communications nodes may be inter-connected by the wireless backhaul links.

The conditions for communicating data via a plurality of wireless communications links may include communications characteristics for communicating via unlicensed wireless access interfaces. The indication of communications characteristics for communicating via unlicensed wireless access interfaces may include a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and/or a bandwidth when transmitting via a wireless communications link. In some embodiments, the communications characteristics for communicating via unlicensed wireless access interfaces include an indication that one of the wireless communications links (such as one of the wireless backhaul links 1026, 1020 used by the first communications node 1006) are formed at least in part by communications resources of an unlicensed wireless access interface. In step S1206, the controlling communications node determines, based on the maintained information of conditions for communicating the data via the plurality wireless communications links of the wireless backhaul network, routing information defining one or more possible routes for communicating the upstream data or the downstream data via the plurality of wireless communications links (such as the first communications path 1040, the second communications path 1060 and/or the third communications path 1080), and the conditions for communicating the upstream or the downstream data on the one or more possible routes. In step S1208, the controlling communications node communicates the routing information to one or more of the communications nodes for each of the one of more communications nodes to configure a routing table for communicating the upstream data or the downstream data on the one or more possible routes via the plurality of wireless communications links. As will be explained in more detail below, the routing information may include the routing table or may include information which enables a communications node which receives the routing information to build a routing table based on the routing information. In some examples, the controlling communications node may configure and transmit the routing table itself. The method ends at step S1210.

A routing table sent, or configured by, a particular communications node may include an identification of each communications path available to that communications node for the transmission of data. For example, a routing table sent by a controlling communications node to the fourth communications node 1004 may indicate that the fourth communications node 1004 can transmit data via the first communications path 1040 or the second communications path 1060. The routing table may also indicate a next-hop node on each communications path. In some embodiments, the controlling communications node may determine the path cost for each communication path in the wireless backhaul network and include the path cost in the routing table. For example, a routing table transmitted from the core network 20 to the fourth communications node 1004 (such as routing table 1090 visible in FIG. 3A) may include an indication of the path cost for each of the first and second communications paths 1040, 1060. The routing table 1090 for the fourth communications node 1004 is reproduced in Table 2 below and indicates that the path cost for the first communications path 1040 is “40” and the path cost for the second communications path 1060 is “8”.

TABLE 2
An example of a routing table for communications
paths in a wireless backhaul network.

| Path ID | Next Hop | Path Cost |
|---|---|---|
| First communications | First Communications | 40 |
| path 1040 | node 1006 | |
| Second communications | Second Communications | 8 |
| path 1060 | node 1008 | |

In accordance with example embodiments, the path cost determined by the controlling communications node for each communications node in the wireless backhaul network may be updated. For example, communications nodes in the wireless backhaul network may transmit assistance information reports to the controlling communications node which are used to re-calculate the path cost. In one example, the first communications node 1006 may transmit an assistance information report to the controlling communications node which includes an indication that it is experiencing severe collisions (for example, the first communications node 1006 determines that a number of detected collision's within a pre-defined time period exceeds a threshold). The first communications node 1006 may use licensed communications resources for the transmission of the report to improve the likelihood of successful transmission to the core network 20. Alternatively, one of the other communications nodes may transmit the assistance information report to the controlling communications node including the indication that the first communications node 1006 is experiencing severe collisions. In one example, the report may be transmitted by a child node of the first communications node 1006 (for example, the fourth communications node 1004) which detects that the first communications node 1006 is experiencing severe collisions and transmits the report to the communications node using a communications path other than the first communications path 1040. In response to receiving such an assistance information report, the controlling communications node may update routing tables maintained at the core network 20 which include communications paths with the affected node (i.e. the first communications node 1006). For example, the core network 20 may include a flag in the routing tables which indicates which communications nodes should be avoided. For example, the controlling communications node may include an indication in Table 2 above that the fourth communications node 1004 should avoid transmitting data along the first communications path 1040 via the first communications node 1006. An example of such a routing table is shown in Table 3.

TABLE 3
An example of an updated routing table including an indication to avoid
a communications node which is experiencing severe collisions.

| Path ID | Next Hop | Path Cost | Flag |
|---|---|---|---|
| First | First | 40 | Avoid First |
| communications | Communications | | Communications |
| path 1040 | node 1006 | | node |
| Second | Second | 8 | N/A |
| communications | Communications | | |
| path 1060 | node 1008 | | |

In this way, the controlling communications node can flexibly control whether or not communications occur via routes using unlicensed communications resources. For example, to increase overall throughput, the controlling communications node may allow communications to occur via communications paths which use unlicensed communications resources but intervenes to avoid particular communications nodes operating on unlicensed resources when they experience severe collisions by transmitting an updated routing table.

In some embodiments, the assistance information reports may include one or more of a received signal strength indicator (RSSI), an interference level or a channel occupancy. The assistance information reports may be configured as a measurement reporting event. For example, if a communications node detects that an RSSI is lower than a predefined threshold, or that interference is higher than a pre-defined threshold or that channel occupancy is above a pre-defined threshold, then the communications node may transmit the assistance information report to the controlling communications node. In some embodiments, the assistance information report may specifically relate to an RSSI, interference level or channel occupancy associated with wireless backhaul links using unlicensed communications resources.

For example, the first communications node 1006, or another communications node acting on behalf of the first communications node 1006, may transmit an assistance information report regarding an RSSI, interference level or channel occupancy of the wireless backhaul links 1020, 1010. In response, the controlling communications node may take the assistance information into account in path cost calculations, or may decide to include a flag in the routing table which instructs communications nodes to avoid the first communications node 1006 as explained above.

A communications node receiving routing information from the controlling communications node may determine a next-hop node based on the routing information. For example, if the controlling communications node transmits a routing table corresponding to Table 3 above to the fourth communications node 1004, then the first communications node may choose either the first communications node 1006 or the second communications node 1004 for transmitting uplink data which it receives from the communications device 1002. For example, the fourth communications node 1008 may choose to transmit data to the second communications node 1008 because the path cost for the second communications path 1060 is lower than for the first communications path 1040.

In some embodiments, the communications node which receives the routing information may also select a communications path based on whether that communications node can support communications on unlicensed frequency resources. For example, the fourth communications node 1004 may choose to transmit data to the second communications node 1008 even if the first communications path 1040 has a superior path cost if the fourth communications node is unable to support unlicensed communications.

As explained in embodiments above, although the controlling communications node may indicate path costs in a routing table transmitted to a communications node, the communications node may ultimately decide which communications node to select as a next-hop node taking into account the routing information provided by the controlling communications node. In alternative embodiments, the controlling communications node may include a specific instruction in the routing table to inform the communications node which receives the routing table that it must use a particular communications path for transmitting data.

Embodiments have been explained above with respect to FIG. 5, where the controlling communications node configures routing information for each communications node in the wireless backhaul network and, in some embodiments, configures a routing table including an indication of a path cost for each route available for the transmission of data by the communications nodes. The path cost configured by the controlling communications node is based at least on an indication that one of the wireless communications links is formed from communications resources of an unlicensed wireless access interface.

In alternative embodiments, the controlling communications node may transmit a routing table which does not include a path cost associated with communications paths. In other embodiments, the controlling communications node transmits a routing table including a path cost but the path cost does not reflect the indication that wireless communications links can operate on unlicensed communications resources. In other embodiments, the communications nodes may be pre-configured with a routing table which does not contain a path cost.

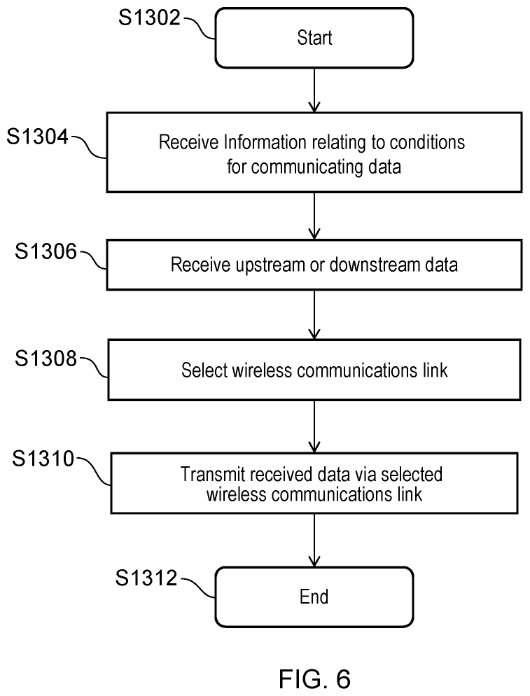

In such embodiments, as shown in FIG. 6, a communications node in the wireless backhaul network may control communication in the wireless backhaul network. The method starts at step S1302. At step S1304, the communications node receives, from one of a plurality of other communications nodes in the wireless backhaul network, information relating to conditions for communicating data via a plurality of wireless communications links between the communications node and the plurality of other communications nodes of the wireless backhaul network. The communications node is configured to communicate downstream data from a core network to one or more communications devices or to communicate upstream data to the core network received from the one or more communications devices via the plurality of wireless communications links. One of the wireless communications links is formed at least in part from communications resources of an unlicensed wireless access interface and the received conditions for communicating the data via the plurality of wireless communications links forming part of the received information includes an indication of communications characteristics for communicating via an unlicensed wireless access interfaces. The indication of communications characteristics for communicating via unlicensed wireless access interfaces may include a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and/or a bandwidth when transmitting via a wireless communications link. In some embodiments, the communications characteristics for communicating via unlicensed wireless access interfaces may include an indication that one of the plurality of wireless communications links is formed at least in part from communications resources of an unlicensed wireless access interface.

For example, the fourth communications node 1004 may receive an indication, from the first communications node 1006, or from another one of the communications nodes, that the first communications node 1006 is configured to operate on unlicensed communications resources. At step S1306, the communications node receives upstream data from the one or more communications devices to communicate to a donor communications node connected to the core network, or downstream data from the donor communications node to transmit to the one or more communications devices. For example, as an example of upstream data, the fourth communications node 1004 may receive uplink data from the communications device 1002 for communicating to the core network 20. At step S1308, the communications node selects, based on the received information of conditions for communicating the data via the wireless communications links, one of the plurality of wireless communications links for communicating the upstream or the downstream data. In some embodiments, where the communications characteristics for communicating via unlicensed wireless access interfaces include an indication that one of the plurality of wireless communications links is formed at least in part from communications resources of an unlicensed wireless access interface, the communications node may select the wireless communications link based on the indication that one of the plurality of wireless communications links is formed at least in part from communications resources of an unlicensed wireless access interface. For example, the fourth communications node 1004 may select the to transmit the uplink data to either the first communications node 1006 (on the first communications path 1040) or the second communications node 1008 (on the second communications path 1060) based on the indication that the first communications node 1006 is configured to operate on unlicensed frequency resources on either its wireless backhaul links 1016, 1020. In step S1310, the communications node communicates the upstream data or the downstream data via the selected one of the wireless communications links. For example, the fourth communications node 1006 may communicate upstream data via the first communications path 1040. The method ends in step S1312.

In some embodiments, each communications node in the wireless backhaul network may broadcast an indication of whether or not it can support operation on unlicensed frequency resources or not to other communications nodes in the wireless backhaul network. In some embodiments, each communications node may broadcast a generalised indication which has been implicitly adapted to account for whether the communications node can operate using unlicensed frequency resources. For example, the generalised indication may indicate expected performance of the communications node on the wireless communications resources including one or more of whether the communications node can provide a reliable connection, a high throughout connection or an emergency service using unlicensed communications resources.

In some embodiments, a child node may transmit an indication to its parent node that it can support unlicensed band operation during an access procedure forming a wireless backhaul link between the child node and the parent node. For example, the child node may form a wireless backhaul link with the parent node using a Random Access Channel (RACH) procedure, and may indicate using the signalling in the RACH procedure, that it can support operation on unlicensed communications resources.

In some embodiments, where the controlling communications node has transmitted a routing table to each communications node including a path cost which has not been adapted to reflect whether communications nodes can operate on unlicensed communications resources, the communications nodes receiving the routing tables may adapt the path cost in the routing table to reflect whether communications nodes on communications paths can operate using unlicensed frequency resources. In one example, the controlling communications node may transmit a routing table to the fourth communications node 1004 which is similar to Table 2 but which gives the path cost for the first communications path 1040 as being “8” because the weighting applied to account for the ability of the first communications node 1006 to operate using unlicensed resources has not yet been applied. In such embodiments, the fourth communications node 1004 itself may change the path cost for the first communications path 1040, based on the indication that the first communications node 1006 can operate on unlicensed frequency resources, by applying the weighting shown in FIG. 4 such that the path cost for the first communications path 1040 is “40”. In some embodiments, a communications node which receives the routing table from the controlling communications node may determine that a path cost determined by the communications node itself has a higher priority than a path cost received in the routing table from the controlling communications node. In such embodiments, the communications node may overwrite or replace the path cost calculated by the controlling communications node in the routing table received from the controlling communications node. An indication of the overwritten or replaced cost may be transmitted from the communications node to the controlling communications node.

In some embodiments, one of the communications nodes may receive an assistance information report from one or more others of the communications nodes in the wireless backhaul network. The assistance information report may include one or more of a received signal strength indicator (RSSI), an interference level or a channel occupancy. For example, if a communications node detects that an RSSI is lower than a predefined threshold, or that interference is higher than a pre-defined threshold or that channel occupancy is above a pre-defined threshold, then that communications node may broadcast this information to other communications nodes. The RSSI, interference level or channel occupancy may be specifically associated with wireless backhaul links using unlicensed communications resources. For example, the first communications node 1006, or another communications node acting on behalf of the first communications node 1006, may transmit information regarding an RSSI, interference level or channel occupancy of the wireless backhaul links 1020, 1010 to surrounding communications nodes. In response, the fourth communications node 1004 may take this information into account in path cost calculations, or may decide to include a flag in the routing table which instructs the fourth communications node to avoid the first communications node 1006.

In some embodiments, the assistance information report may indicate characteristics of wireless communications links formed at least in part from communications resources of a wireless access interface. For example, the assistance information report may indicate that a communication node can operate using a WiFi band or millimetre wave band. In some cases, the probability of collision using a WiFi band is higher than for using a millimetre wave band. As such, a communications node takes this indication into account when making a routing decision.

In some embodiments, the assistance information report may include an indication that a communications node can operate using the unlicensed communications resources with geo-location based co-ordination or automated frequency co-ordination. This indication may imply that there is a lower probability of collision associated with using the unlicensed communications resources, than if the communications resources were not used with geo-location based co-ordination or automated frequency co-ordination. For example, for 6 GHz unlicensed operation, communications devices operating using geolocation or automated frequency co-ordination may be allowed to use a higher transmission power suitable for outdoor use, which lowers the probability of collisions when using unlicensed communications resources.

As explained above, the decision of which communications path to select is based on at least an indication of whether communications nodes on the communications path can support operation on unlicensed communications resources. In example embodiments, a communications path may be selected based on an indication of whether communications nodes on the communications path can support operation on unlicensed communications resources and on a quality of service (QoS) requirement of data to be transmitted along the selected communications path. For example, packets with stringent delay requirements (such as URLLC data packets) may not be transmitted via communications paths with communications nodes operating on unlicensed resources. However, packets with less stringent delay requirements (such as eMBB data packets like video, virtual reality) but which have higher bandwidth requirements may be transmitted via communications paths with communications nodes operating on unlicensed resources. For example, a millimetre wave unlicensed band may have a relatively low probability of collisions but has a shorter range (approximately less than 50 m) than lower frequency unlicensed bands, and also requires a line of sight for successful transmission or reception. Accordingly, it may be advantageous to effectively expand the communications range for millimetre wave unlicensed bands by using multi-hopping as long as end-to-end latency requirements for the data packet are met. For example, eMBB transmission may allow multi-hopping, but the number of hopping should be limited due to delay requirement. On the other hand, mMTC data packet, which is delay tolerant traffic, may allow the multi-hopping and the number of hopping is not limited. In a particular example, the fourth communications node 1004 may receive uplink data from the communications device 1002 and detects a QoS requirement associated with the received uplink data. When deciding whether to select the first communications node 1006 or the second communications node 1008 as the next hop-node for forwarding the uplink data to, the fourth communications node 1004 may base the decision both on the detected QoS requirement of the received uplink data packets and the indication that the first communications node 1006 can operate on unlicensed communications resources.

In some embodiments, a communications node may receive updates of the performance of communications using the unlicensed communications resources, and use the updates to inform its decision of which communications path to select. For example, a communications node may determine that one of its neighbouring nodes is busy. In other words, the communications node may detect that a number of collisions within a pre-defined period is over a threshold for one if its neighbouring nodes or the communications node may detect that a channel occupancy for a channel used by the neighbouring node exceeds a pre-defined threshold. In such cases, the communications node may update its routing table to label routes with busy communications nodes as temporarily unavailable. The label may expire after a pre-determined period of time in one example. In a particular example, the fourth communications node 1004 may determine that the first communications node 1006 is busy because the fourth communications node 1004 detects that a number of collisions within a pre-defined period exceeds a threshold for communications along the first communications path 1040. For example, the fourth communications node 1004 may detect the collisions itself on wireless backhaul link 1020 or the first rely node 1006 may inform the fourth communications node 1004 of collisions on wireless backhaul link 1016. In response, the fourth communications node 1004 updates its routing table to label the first communications path 1040 as unavailable for a specified time period. In such cases, the fourth communications node 1004 will select to transmit data via the second communications path 1060. This time period can be determined by an average collision resolve time period or the period the node is going to perform next sensing.

In some embodiments, the indication of whether communications nodes on communications paths operate using unlicensed frequency resources may be communicated to a communications node making a routing decision in a Backhaul Adaptation Protocol (BAP) header of a data packet. For example, the core network 20 may transmit a path cost to the fourth communications node 1004 for the first communications path in a BAP header which is adapted to reflect that the first communications node 1006 operates on unlicensed frequency resources.

### Route Selection Triggers

As discussed above with reference to FIG. 3A, a route selection procedure may be triggered by a detection that a wireless communications link has failed (for example, a detection that RLF has occurred on the third communications path 1080). As will be appreciated by one skilled in the art, a route selection procedure may be alternatively triggered by detection of one or more of the following:
A link quality is getting worse (determined through the measurements of received reference signals, from the parent node or elsewhere);
A link cannot guarantee the QoS requirement (for example delay requirement, which may be determined through reception of a broadcast or dedicated transmission from the parent node);
A parent communications node is overloaded (determined through reception of a broadcast or dedicated transmission from the parent node);
A route selection criterion is changed, for example to minimise the hop count so as to maximise network capacity (determined through notification from an upstream node, for example);
To improve load balancing across wireless communications links;
To avoid unreliable wireless communications links; or
There is an uplink overflow (for example, the child node determines that it has more data to send than has resources allocated in the uplink grant, or no more uplink grant is being allocated).

In addition to the above, a communications node may either continuously or periodically monitor path costs associated with communications paths and switch to another communications path when the path cost for the communications path currently being used for transmitting data is no longer superior to a path cost for another communications path available to the communications node.

### Network Components

A more detailed diagram of some of the components of the network shown in FIG. 2 is provided by FIG. 7. In FIG. 7, a TRP 10 as shown in FIG. 2 comprises, as a simplified representation, a wireless transmitter circuitry 30, a wireless receiver circuitry 32 and a controller or controlling processor circuitry 34 which may operate to control the transmitter 30 and the wireless receiver 32 to transmit and receive radio signals to one or more UEs 14 within a cell 12 formed by the TRP 10. As shown in FIG. 7, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44, 48 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 7, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40

Though embodiments of the present technique have been described largely by way of the example system shown in FIG. 3A, it would be clear to those skilled in the art that they could be equally applied to other systems, where for example there may be many more nodes or paths to choose from, or more hops between the donor and end nodes.

Those skilled in the art would appreciate that the method shown by FIGS. 5 and 6 may be adapted in accordance with embodiments of the present technique. For example, other intermediate steps may be included in the method, or the steps may be performed in any logical order.

Those skilled in the art would also appreciate that such communications nodes and/or wireless communications networks as herein defined may be further defined in accordance with the various arrangements and embodiments discussed in the preceding paragraphs. It would be further appreciated by those skilled in the art that such communications nodes and wireless communications networks as herein defined and described may form part of communications systems other than those defined by the present invention.

According some example embodiments, there is provided a method of controlling communication in a wireless backhaul network by a communications node in the wireless backhaul network. The communications node receives, from one of a plurality of other communications nodes in the wireless backhaul network, information relating to conditions for communicating data via a plurality of wireless communications links between the communications node and the plurality of other communications nodes. The communications node is configured to communicate downstream data from a core network to one or more communications devices or to communicate upstream data to the core network received from the one or more communications devices via the plurality of wireless communications links. One of the wireless communications links is formed at least in part from communications resources of an unlicensed wireless access interface. The received conditions for communicating the data via the plurality of wireless communications links forming part of the received information includes an indication of communications characteristics for communicating via unlicensed wireless access interfaces. The communications node receives upstream data from the one or more communications devices to communicate to a donor communications node connected to the core network, or downstream data from the donor communications node to transmit to the one or more communications devices. The communications node selects, based on the received information of conditions for communicating the data via the wireless communications links, one of the plurality of wireless communications links for communicating the upstream or the downstream data. The communications node communicates the upstream data or the downstream data via the selected one of the wireless communications links.

According to some example embodiments, there is provided a method of controlling communication, by a controlling communications node, in a wireless backhaul network. The wireless backhaul network comprises a plurality of communications nodes one of which is the controlling communications node. The controlling communications node maintains relating to conditions for communicating data via a plurality of wireless communications links between the communications nodes of the wireless backhaul network. The wireless backhaul network is configured to communicate downstream data from a core network for transmitting to one or more communications devices or to communicate upstream data to the core network received from the one or more communications devices. The communications nodes of the wireless backhaul network are inter-connected with at least one of the communications nodes connected to a plurality of other communications nodes for communicating the upstream data or the downstream data. The controlling communications node selects based on the maintained information of conditions for communicating the data via the plurality of wireless communications links of the wireless backhaul network, one or more routes for communicating the upstream data or the downstream data via the plurality of wireless communications links. The controlling communications node communicates an indication of the selected one or more routes to one or more of the communications nodes for each of the one or more communications nodes to communicate the upstream or the downstream data on the one or more selected routes. One of the plurality of wireless communications links is formed at least in part from communications resources of an unlicensed wireless access interface, and the conditions for communicating the data via the plurality of wireless communications links forming part of the maintained information includes an indication of communications characteristics for communicating via unlicensed wireless access interfaces.

The following numbered paragraphs provide further example aspects and features of the present technique:
Paragraph 1. A method of controlling communication, by a controlling communications node, in a wireless backhaul network, the wireless backhaul network comprising a plurality of communications nodes one of which is the controlling communications node, the method comprising
   maintaining information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   determining, based on the maintained information of conditions for communicating the data via the plurality of wireless communications links of the wireless backhaul network, routing information defining one or more possible routes for communicating the upstream data or the downstream data via the plurality of wireless communications links and the conditions for communicating the upstream or the downstream data on the one or more possible routes, and
   communicating the routing information to one or more of the communications nodes, for each of the one of more communications nodes to configure a routing table for communicating the upstream data or the downstream data on the one or more possible routes via the plurality of wireless communications links, wherein one of the plurality of wireless communications links is formed at least in part from communications resources of an unlicensed wireless access interface, and the conditions for communicating the upstream or the downstream data on the one or more possible routes forming part of the routing information includes an indication of communications characteristics for communicating via unlicensed wireless access interfaces.
Paragraph 2. A method according to paragraph 1, wherein the indication of communications characteristics for communicating via unlicensed wireless access interfaces includes at least one of a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and a bandwidth when transmitting via a wireless communications link.
Paragraph 3. A method according to paragraph 1 or 2, wherein the indication of the communications conditions for communicating the upstream data or the downstream data on the one or more possible routes via the plurality of wireless communications links included in the routing information is used by the one of more communications nodes to configure their routing table from which the one or more of communications nodes can select one or more of the possible routes based on the routing information.
Paragraph 4. A method according to any of paragraphs 1 to 3, wherein the determining the routing information, comprises
   determining, based on the maintained information, a path cost for the one or more possible routes for communicating the upstream data and the downstream data, and
   the communicating the routing information to one or more of the communications nodes for each of the one or more communications nodes to configure a routing table comprises
   including, in the routing information, the path cost of the possible routes for each of the one or more communications nodes to configure the routing table for communicating the upstream data or the downstream data on the one or more possible routes, wherein the indication of communications characteristics for communicating via unlicensed wireless access interfaces is represented by a path cost for routes which include the one or more wireless communications links; and
   communicating, to each of the one or more communications nodes, the routing information including the path cost for each of the one or more possible routes for each of the one or more communications nodes to configure the routing table for communicating the upstream data or the downstream data on the one or more possible routes.
Paragraph 5. A method according to paragraph 4, wherein the routing information includes the indication of communications characteristics for communicating via unlicensed wireless access interfaces and one or more of a link capacity, bandwidth or load of the plurality of wireless communications links and
   the determining, based on the routing information, a path cost for the one or more routes for communicating the upstream data and the downstream data comprises
   determining, the path cost based on the indication of communications characteristics for communicating via unlicensed wireless access interfaces and one or more of a link capacity, bandwidth or load of the wireless communications links.
Paragraph 6. A method according to paragraph 4 or paragraph 5, comprising
   receiving, from one or more of the communications nodes which received the routing information to configure a routing table for communicating the upstream data or the downstream data on the one or more possible routes, an assistance information report including an updated indication of communications characteristics for communicating via unlicensed wireless access interfaces; and in response,
   updating the determined path cost of the routes which include the one or more wireless communications links resources;
   updating the routing information to include the updated path cost of the routes which include the one or more wireless communications; and
   communicating the updated routing information to one or more of the communications nodes from which the assistance information report was received to configure an updated routing table for communicating the upstream data or the downstream data one or more possible routes
Paragraph 7. A method according to paragraph 6, wherein the assistance information report includes one or more of a received signal strength indicator, RSSI, an interference level, a number of detected collisions in a pre-defined period of time or a channel occupancy associated with the one or more wireless communications links.
Paragraph 8. A method according to any of paragraphs 4 to 7, wherein the communicating, to each of the one or more communications nodes, the routing information including the path cost of each of the determined routes for each of the one or more communications nodes to configure the routing table for communicating the upstream data or the downstream data one the one or more possible routes comprises communicating the path cost for each of the determined routes in a Backhaul Adaptation Protocol, BAP, header of a data packet.
Paragraph 9. A method of controlling communication in a wireless backhaul network by a communications node in the wireless backhaul network, the method comprising
   receiving, by the communications node from one of a plurality of other communications nodes in the wireless backhaul network, information relating to conditions for communicating data via a plurality of wireless communications links between the communications node and the plurality of other communications nodes, the communications node being configured to communicate downstream data from a core network to one or more communications devices or to communicate upstream data to the core network received from the one or more communications devices via the plurality of wireless communications links, wherein one of the wireless communications links is formed at least in part from communications resources of an unlicensed wireless access interface and the received conditions for communicating the data via the plurality of wireless communications links forming part of the received information includes an indication of communications characteristics for communicating via unlicensed wireless access interfaces;
   receiving, by the communications node, upstream data from the one or more communications devices to communicate to a donor communications node connected to the core network, or downstream data from the donor communications node to transmit to the one or more communications devices;
   selecting, based on the received information of conditions for communicating the data via the wireless communications links, one of the plurality of wireless communications links for communicating the upstream or the downstream data, and
   communicating the upstream data or the downstream data via the selected one of the wireless communications links.
Paragraph 10. A method according to paragraph 9, wherein the indication of communications characteristics for communicating via unlicensed wireless access interfaces includes at least one of a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and a bandwidth when transmitting via a wireless communications link.
Paragraph 11. A method according to any of paragraphs 9 or 10, comprising
   receiving, from the donor communications node, a routing table indicating a plurality of communications paths along which the communications node is configured to communicate the received upstream or the received downstream data, wherein
   the selecting, based on the received information of conditions for communicating the data via the wireless communications links, one of the plurality of wireless communications links for communicating the upstream or the downstream data comprises
   determining a path cost for each of the plurality of communications paths indicated by the received routing table based on the received information of conditions for communicating the data via the wireless communications links, and
   selecting, based on the determined path cost for each of the plurality of communications paths indicated by the routing table, one of the plurality of communications paths along which to communicate the received upstream or the received downstream data.
Paragraph 12. A method according to paragraph 11, wherein the routing table received from the donor communications node includes an indication of a path cost calculated by the donor communications node for each of the plurality of communications paths, and
   the determining a path cost for each of the plurality of communications paths indicated by the received routing table based on the received information of conditions for communicating the data via the wireless communications links comprises
   modifying, based on the received information of conditions for communicating the data via the wireless communications links, the path cost calculated by the donor communications node for each of the plurality of communications paths.
Paragraph 13. A method according to paragraph 12, wherein the modifying, based on the received information of conditions for communicating the data via the wireless communications links, the path cost calculated by the donor communications node for each of the plurality of communications paths comprises
   determining that the path cost determined for each of the plurality of communications paths by the communications node has a higher priority than the path cost calculated for each of the plurality of communications paths by the donor communications node and, in response,
   replacing the path cost for each of the plurality of communications paths calculated by the donor communications nodes with the path cost calculated by the communications node for each of the plurality of communications paths in the routing table received from the donor communications node.
Paragraph 14. A method according to any of paragraphs 9 to 13, wherein the receiving, by the communications node, the information relating to conditions for communicating data via the wireless communications links comprises
   receiving the information from one or more of the plurality of other communications nodes in the wireless backhaul network as part of a broadcast; or
   receiving the information from one or more of the plurality of other communications nodes in the wireless backhaul network as dedicated signals.
Paragraph 15. A method according to any of paragraphs 9 to 13, wherein the receiving, by the communications node, the information relating to conditions for communicating data via the wireless communications links comprises
   receiving the information from one or more of the plurality of other communications nodes in the wireless backhaul network as part of an access procedure performed between the communications node and the one or more communications nodes from which the information is received.
Paragraph 16. A method according to any of paragraphs 9 to 15, wherein the receiving, by the communications node, the information relating to conditions for communicating the data via the wireless communications links comprises receiving, from one or more of the plurality of other communications nodes, an assistance information report including an updated indication of communications characteristics for communicating via unlicensed wireless access interfaces, wherein
   the selecting, based on the received information of conditions for communicating the data via the wireless communications links, one of the plurality of wireless communications links for communicating the upstream or the downstream data comprises
   selecting the one of the plurality of wireless communications links for communicating the upstream or the downstream data based on the received assistance information report.
Paragraph 17. A method according to paragraph 16, wherein the assistance information report includes one or more of a received signal strength indicator, RSSI, an interference level, a number of detected collisions in a pre-determined time period or a channel occupancy associated with the plurality of wireless communications links.
Paragraph 18. A method according to any of paragraphs 9 to 17, wherein the indication of communications characteristics for communicating via unlicensed wireless access interfaces includes an indication of characteristics of the communications resources of the unlicensed wireless access interfaces.
Paragraph 19. A method according to paragraph 18, wherein the indication of the characteristics of the communications resources of the unlicensed wireless access interfaces include an indication of whether the communications resources of the unlicensed wireless access interface belong to a millimetre wave band or Wi-Fi wave band.
Paragraph 20. A method according to any of paragraphs 9 to 19, wherein the indication of communications characteristics for communicating via unlicensed wireless access interfaces includes an indication that the communications resources of the unlicensed wireless access interfaces are being used with geo-location based co-ordination or automated frequency co-ordination.
Paragraph 21. A method according to any of paragraphs 9 to 20, comprising
   determining, by the communications node, a quality of service requirement associated the received upstream or the received downstream data, wherein
   the selecting, based on the received information of conditions for communicating the data via the wireless communications links, one of the plurality of wireless communications links for communicating the upstream or the downstream data comprises
   selecting the one of the plurality of wireless communications links for communicating the upstream or the downstream data based on the determined quality of service requirement associated with the received upstream or the received downstream data and the received information of conditions for communicating the data via the wireless communications links.
Paragraph 22. A method according to any of paragraphs 9 to 18, comprising
   determining, by the communications node based on the information relating to conditions for communicating data via the wireless communications links, that a number of collisions on at least one of the wireless communications links exceeds a pre-defined threshold;
   setting an avoidance timer for the at least one wireless communications link, and in response,
   refraining from communicating data via the at least one wireless communications link for a duration of the avoidance timer.
Paragraph 23. A method of controlling communication, by a controlling communications node, in a wireless backhaul network, the wireless backhaul network comprising a plurality of communications nodes one of which is the controlling communications node, the method comprising
   maintaining information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   selecting, based on the maintained information of conditions for communicating the data via the plurality of wireless communications links of the wireless backhaul network, one or more routes for communicating the upstream data or the downstream data via the plurality of wireless communications links, and
   communicating an indication of the selected one or more routes to one or more of the communications nodes for each of the one or more communications nodes to communicate the upstream or the downstream data on the one or more selected routes, wherein one of the plurality of wireless communications links is formed at least in part from communications resources of an unlicensed wireless access interface, and the conditions for communicating the data via the plurality of wireless communications links forming part of the maintained information includes an indication of communications characteristics for communicating via unlicensed wireless access interfaces.
Paragraph 24. A controlling communications node forming part a wireless backhaul network comprising a plurality of communications nodes one of which is the controlling communications node, the controlling communications node comprising
   transceiver circuitry configured to transmit and/or to receive signals;
   control circuitry configured to
   maintain information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   determine, based on the maintained information of conditions for communicating the data via the plurality of wireless communications links of the wireless backhaul network, routing information defining one or more possible routes for communicating the upstream data or the downstream data via the plurality of wireless communications links and the conditions for communicating the upstream or the downstream data on the one or more possible routes, and the control circuitry is configured in combination with the transceiver circuitry to
   communicate the routing information to one or more of the communications nodes, for each of the one of more communications nodes to configure a routing table for communicating the upstream data or the downstream data on the one or more possible routes via the plurality of wireless communications links, wherein one of the plurality of wireless communications links is formed at least in part from communications resources of an unlicensed wireless access interface, and the conditions for communicating the upstream or the downstream data on the one or more possible routes forming part of the routing information includes an indication of communications characteristics for communicating via unlicensed wireless access interfaces.
Paragraph 25. A communications node in a wireless backhaul network, the communications node comprising
   transceiver circuitry configured to transmit and/or to receive signals;
   control circuitry configured in combination with the transceiver circuitry to
   receive, from a plurality of other communications nodes in the wireless backhaul network, information relating to conditions for communicating data via a plurality of wireless communications links between the communications node and the plurality of other communications nodes, the communications node being configured to communicate downstream data from a core network to one or more communications devices or to communicate upstream data to the core network received from the one or more communications devices via the plurality of wireless communications links, wherein one of the wireless communications links is formed at least in part from communications resources of an unlicensed wireless access interface and the conditions for communicating the data via the plurality of wireless communications links forming part of the received information includes an indication of communications characteristics for communicating via unlicensed wireless access interfaces;
   receive upstream data from the one or more communications devices to communicate to a donor communications node connected to the core network, or downstream data from the donor communications node to transmit to the one or more communications devices;
   select, based on the received information of conditions for communicating the data via the wireless communications links, one of the plurality of wireless communications links for communicating the upstream or the downstream data, and
   communicate the upstream data or the downstream data via the selected one of the wireless communications links.
Paragraph 26. A controlling communications node in a wireless backhaul network, the wireless backhaul network comprising a plurality of communications nodes one of which is the controlling communications node, the controlling communications node comprising
   transceiver circuitry configured to transmit and/or to receive signals;
   control circuitry configured to
   maintain information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   select, based on the maintained information of conditions for communicating the data via the plurality of wireless communications links of the wireless backhaul network, one or more routes for communicating the upstream data or the downstream data via the plurality of wireless communications links, and the control circuitry is configured in combination with the transceiver circuitry to
   communicate an indication of the selected one or more routes to one or more of the communications nodes for each of the one or more communications nodes to communicate the upstream or the downstream data on the one or more selected routes, wherein one of the plurality of wireless communications links is formed at least in part from communications resources of an unlicensed wireless access interface, and the conditions for communicating the data via the plurality of wireless communications links forming part of the maintained information includes an indication of communications characteristics for communicating via unlicensed wireless access interfaces.
Paragraph 27. A wireless backhaul network including a controlling communications node according to paragraph 24 or paragraph 26 and a communications node according to paragraph 25.
Paragraph 28. A computer program comprising instructions which, when the program is executed by a computer, cause the computer to carry out the method of paragraph 1 or paragraph 9 or paragraph 23.
Paragraph 29. Circuitry for a controlling communications node forming part a wireless backhaul network comprising a plurality of communications nodes one of which is the controlling communications node, the circuitry comprising
   transceiver circuitry configured to transmit and/or to receive signals;
   control circuitry configured to
   maintain information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   determine, based on the maintained information of conditions for communicating the data via the plurality of wireless communications links of the wireless backhaul network, routing information defining one or more possible routes for communicating the upstream data or the downstream data via the plurality of wireless communications links and the conditions for communicating the upstream or the downstream data on the one or more possible routes, and the control circuitry is configured in combination with the transceiver circuitry to
   communicate the routing information to one or more of the communications nodes, for each of the one of more communications nodes to configure a routing table for communicating the upstream data or the downstream data on the one or more possible routes via the plurality of wireless communications links, wherein one of the plurality of wireless communications links is formed at least in part from communications resources of an unlicensed wireless access interface, and the conditions for communicating the upstream or the downstream data on the one or more possible routes forming part of the routing information includes an indication of communications characteristics for communicating via unlicensed wireless access interfaces.
Paragraph 30. Circuitry for a communications node in a wireless backhaul network, the circuitry comprising
   transceiver circuitry configured to transmit and/or to receive signals;
   control circuitry configured in combination with the transceiver circuitry to
   receive, from a plurality of other communications nodes in the wireless backhaul network, information relating to conditions for communicating data via a plurality of wireless communications links between the communications node and the plurality of other communications nodes, the communications node being configured to communicate downstream data from a core network to one or more communications devices or to communicate upstream data to the core network received from the one or more communications devices via the plurality of wireless communications links, wherein one of the wireless communications links is formed at least in part from communications resources of an unlicensed wireless access interface and the conditions for communicating the data via the plurality of wireless communications links forming part of the received information includes an indication of communications characteristics for communicating via unlicensed wireless access interfaces;
   receive upstream data from the one or more communications devices to communicate to a donor communications node connected to the core network, or downstream data from the donor communications node to transmit to the one or more communications devices;
   select, based on the received information of conditions for communicating the data via the wireless communications links, one of the plurality of wireless communications links for communicating the upstream or the downstream data, and
   communicate the upstream data or the downstream data via the selected one of the wireless communications links.
Paragraph 31. Circuitry for a controlling communications node in a wireless backhaul network, the wireless backhaul network comprising a plurality of communications nodes one of which is the controlling communications node, the circuitry comprising
   transceiver circuitry configured to transmit and/or to receive signals;
   control circuitry configured to
   maintain information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
   select, based on the maintained information of conditions for communicating the data via the plurality of wireless communications links of the wireless backhaul network, one or more routes for communicating the upstream data or the downstream data via the plurality of wireless communications links, and the control circuitry is configured in combination with the transceiver circuitry to
   communicate an indication of the selected one or more routes to one or more of the communications nodes for each of the one or more communications nodes to communicate the upstream or the downstream data on the one or more selected routes, wherein one of the plurality of wireless communications links is formed at least in part from communications resources of an unlicensed wireless access interface, and the conditions for communicating the data via the plurality of wireless communications links forming part of the maintained information includes an indication of communications characteristics for communicating via unlicensed wireless access interfaces.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-161901, “Revised work item proposal: Enhancements of NB-IoT”, Huawei, HiSilicon, 3GPP TSG RAN Meeting #73, New Orleans, USA, Sep. 19-22, 2016.
[3] RP-170831, “New SID Proposal: Study on Integrated Access and Backhaul for NR”, AT&T, 3GPP RAN Meeting #75, Dubrovnik, Croatia, March 2017.
[4] R3-181502, “Way Forward—IAB Architecture for L2/3 relaying”, Qualcomm et al, 3GPP TSG-RAN WG3 Meeting #99, Athens, Greece, Feb. 26-Mar. 2, 2018.
[5] R3-185312, “IAB failure recovery as part of route management”, Samsung, 3GPP TSG-RAN WG3 Meeting #101, Gothenburg, Sweden, Aug. 20-24, 2018.
[6] “802.1Q-2014—Bridges and Bridged Networks”, IEEE, December 2014.

1. A method of controlling communication, by a controlling communications node, in a wireless backhaul network, the wireless backhaul network comprising a plurality of communications nodes one of which is the controlling communications node, the method comprising
maintaining information at the controlling communications node relating to conditions for communicating data via a plurality of wireless communications links between the communications nodes of the wireless backhaul network, the wireless backhaul network being configured to communicate downstream data from a core network for transmitting to one or more communications devices or to communicate upstream data to the core network received from the one or more communications devices, the communications nodes of the wireless backhaul network being inter-connected with at least one of the communications nodes connected to a plurality of other communications nodes for communicating the upstream data or the downstream data,
determining, based on the maintained information of conditions for communicating the data via the plurality of wireless communications links of the wireless backhaul network, routing information defining one or more possible routes for communicating the upstream data or the downstream data via the plurality of wireless communications links and the conditions for communicating the upstream or the downstream data on the one or more possible routes, and
communicating the routing information to one or more of the communications nodes, for each of the one of more communications nodes to configure a routing table for communicating the upstream data or the downstream data on the one or more possible routes via the plurality of wireless communications links, wherein one of the plurality of wireless communications links is formed at least in part from communications resources of an unlicensed wireless access interface, and the conditions for communicating the upstream or the downstream data on the one or more possible routes forming part of the routing information includes an indication of communications characteristics for communicating via unlicensed wireless access interfaces.

2. A method according to claim 1, wherein the indication of communications characteristics for communicating via unlicensed wireless access interfaces includes at least one of a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and a bandwidth when transmitting via a wireless communications link.

3. A method according to claim 1, wherein the indication of the communications conditions for communicating the upstream data or the downstream data on the one or more possible routes via the plurality of wireless communications links included in the routing information is used by the one of more communications nodes to configure their routing table from which the one or more of communications nodes can select one or more of the possible routes based on the routing information.

4. A method according to claim 1, wherein the determining the routing information, comprises
determining, based on the maintained information, a path cost for the one or more possible routes for communicating the upstream data and the downstream data, and
the communicating the routing information to one or more of the communications nodes for each of the one or more communications nodes to configure a routing table comprises
including, in the routing information, the path cost of the possible routes for each of the one or more communications nodes to configure the routing table for communicating the upstream data or the downstream data on the one or more possible routes, wherein the indication of communications characteristics for communicating via unlicensed wireless access interfaces is represented by a path cost for routes which include the one or more wireless communications links; and
communicating, to each of the one or more communications nodes, the routing information including the path cost for each of the one or more possible routes for each of the one or more communications nodes to configure the routing table for communicating the upstream data or the downstream data on the one or more possible routes.

5. A method according to claim 4, wherein the routing information includes the indication of communications characteristics for communicating via unlicensed wireless access interfaces and one or more of a link capacity, bandwidth or load of the plurality of wireless communications links and
the determining, based on the routing information, a path cost for the one or more routes for communicating the upstream data and the downstream data comprises
determining, the path cost based on the indication of communications characteristics for communicating via unlicensed wireless access interfaces and one or more of a link capacity, bandwidth or load of the wireless communications links.

6. A method according to claim 4, comprising
receiving, from one or more of the communications nodes which received the routing information to configure a routing table for communicating the upstream data or the downstream data on the one or more possible routes, an assistance information report including an updated indication of communications characteristics for communicating via unlicensed wireless access interfaces; and in response,
updating the determined path cost of the routes which include the one or more wireless communications links resources;
updating the routing information to include the updated path cost of the routes which include the one or more wireless communications; and
communicating the updated routing information to one or more of the communications nodes from which the assistance information report was received to configure an updated routing table for communicating the upstream data or the downstream data one or more possible routes

7. A method according to claim 6, wherein the assistance information report includes one or more of a received signal strength indicator, RSSI, an interference level, a number of detected collisions in a pre-defined period of time or a channel occupancy associated with the one or more wireless communications links.

8. A method according to claim 4, wherein the communicating, to each of the one or more communications nodes, the routing information including the path cost of each of the determined routes for each of the one or more communications nodes to configure the routing table for communicating the upstream data or the downstream data one the one or more possible routes comprises
communicating the path cost for each of the determined routes in a Backhaul Adaptation Protocol, BAP, header of a data packet.

9. A method of controlling communication in a wireless backhaul network by a communications node in the wireless backhaul network, the method comprising
receiving, by the communications node from one of a plurality of other communications nodes in the wireless backhaul network, information relating to conditions for communicating data via a plurality of wireless communications links between the communications node and the plurality of other communications nodes, the communications node being configured to communicate downstream data from a core network to one or more communications devices or to communicate upstream data to the core network received from the one or more communications devices via the plurality of wireless communications links, wherein one of the wireless communications links is formed at least in part from communications resources of an unlicensed wireless access interface and the received conditions for communicating the data via the plurality of wireless communications links forming part of the received information includes an indication of communications characteristics for communicating via unlicensed wireless access interfaces;
receiving, by the communications node, upstream data from the one or more communications devices to communicate to a donor communications node connected to the core network, or downstream data from the donor communications node to transmit to the one or more communications devices;
selecting, based on the received information of conditions for communicating the data via the wireless communications links, one of the plurality of wireless communications links for communicating the upstream or the downstream data, and
communicating the upstream data or the downstream data via the selected one of the wireless communications links.

10. A method according to claim 9, wherein the indication of communications characteristics for communicating via unlicensed wireless access interfaces includes at least one of a likelihood of contention when accessing communications resources of a wireless communications link, a delay in accessing communications resources on a wireless communications link, a signal to interference ratio when communicating via a wireless communications link, a maximum transmission power when transmitting via a wireless communications link, and a bandwidth when transmitting via a wireless communications link.

11. A method according to claim 9, comprising
receiving, from the donor communications node, a routing table indicating a plurality of communications paths along which the communications node is configured to communicate the received upstream or the received downstream data, wherein
the selecting, based on the received information of conditions for communicating the data via the wireless communications links, one of the plurality of wireless communications links for communicating the upstream or the downstream data comprises
determining a path cost for each of the plurality of communications paths indicated by the received routing table based on the received information of conditions for communicating the data via the wireless communications links, and
selecting, based on the determined path cost for each of the plurality of communications paths indicated by the routing table, one of the plurality of communications paths along which to communicate the received upstream or the received downstream data.

12. A method according to claim 11, wherein the routing table received from the donor communications node includes an indication of a path cost calculated by the donor communications node for each of the plurality of communications paths, and
the determining a path cost for each of the plurality of communications paths indicated by the received routing table based on the received information of conditions for communicating the data via the wireless communications links comprises
modifying, based on the received information of conditions for communicating the data via the wireless communications links, the path cost calculated by the donor communications node for each of the plurality of communications paths.

13. A method according to claim 12, wherein the modifying, based on the received information of conditions for communicating the data via the wireless communications links, the path cost calculated by the donor communications node for each of the plurality of communications paths comprises
determining that the path cost determined for each of the plurality of communications paths by the communications node has a higher priority than the path cost calculated for each of the plurality of communications paths by the donor communications node and, in response,
replacing the path cost for each of the plurality of communications paths calculated by the donor communications nodes with the path cost calculated by the communications node for each of the plurality of communications paths in the routing table received from the donor communications node.

14. A method according to claim 9, wherein the receiving, by the communications node, the information relating to conditions for communicating data via the wireless communications links comprises
receiving the information from one or more of the plurality of other communications nodes in the wireless backhaul network as part of a broadcast; or
receiving the information from one or more of the plurality of other communications nodes in the wireless backhaul network as dedicated signals.

15. A method according to claim 9, wherein the receiving, by the communications node, the information relating to conditions for communicating data via the wireless communications links comprises
receiving the information from one or more of the plurality of other communications nodes in the wireless backhaul network as part of an access procedure performed between the communications node and the one or more communications nodes from which the information is received.

16. A method according to claim 9, wherein the receiving, by the communications node, the information relating to conditions for communicating the data via the wireless communications links comprises receiving, from one or more of the plurality of other communications nodes, an assistance information report including an updated indication of communications characteristics for communicating via unlicensed wireless access interfaces, wherein
the selecting, based on the received information of conditions for communicating the data via the wireless communications links, one of the plurality of wireless communications links for communicating the upstream or the downstream data comprises
selecting the one of the plurality of wireless communications links for communicating the upstream or the downstream data based on the received assistance information report.

17. A method according to claim 16, wherein the assistance information report includes one or more of a received signal strength indicator, RSSI, an interference level, a number of detected collisions in a pre-determined time period or a channel occupancy associated with the plurality of wireless communications links.

18. A method according to claim 9, wherein the indication of communications characteristics for communicating via unlicensed wireless access interfaces includes an indication of characteristics of the communications resources of the unlicensed wireless access interfaces.

19. A method according to claim 18, wherein the indication of the characteristics of the communications resources of the unlicensed wireless access interfaces include an indication of whether the communications resources of the unlicensed wireless access interface belong to a millimetre wave band or Wi-Fi wave band.

20.-24. (canceled)

25. A communications node in a wireless backhaul network, the communications node comprising
transceiver circuitry configured to transmit and/or to receive signals;
control circuitry configured in combination with the transceiver circuitry to
receive, from a plurality of other communications nodes in the wireless backhaul network, information relating to conditions for communicating data via a plurality of wireless communications links between the communications node and the plurality of other communications nodes, the communications node being configured to communicate downstream data from a core network to one or more communications devices or to communicate upstream data to the core network received from the one or more communications devices via the plurality of wireless communications links, wherein one of the wireless communications links is formed at least in part from communications resources of an unlicensed wireless access interface and the conditions for communicating the data via the plurality of wireless communications links forming part of the received information includes an indication of communications characteristics for communicating via unlicensed wireless access interfaces;
receive upstream data from the one or more communications devices to communicate to a donor communications node connected to the core network, or downstream data from the donor communications node to transmit to the one or more communications devices;
select, based on the received information of conditions for communicating the data via the wireless communications links, one of the plurality of wireless communications links for communicating the upstream or the downstream data, and
communicate the upstream data or the downstream data via the selected one of the wireless communications links.

26.-31. (canceled)
